(19) United States
(12) Patent Application Publication
(10) Pub. No.: US 2025/0230891 A1
(43) Pub. Date: Jul. 17, 2025

(54) PIPE ASSEMBLY

(71) Applicant: HANGZHOU QIWANG TECHNOLOGY CO., LTD., HANGZHOU (CN)

(72) Inventor: GUOQIANG ZHU, HANGZHOU (CN)

(21) Appl. No.: 18/735,740

(22) Filed: Jun. 6, 2024

(30) Foreign Application Priority Data
Jan. 17, 2024 (CN) 202420112542.7

(51) Int. Cl. F16L 53/35; F16L 59/02

(52) U.S. Cl. CPC F16L 53/35; F16L 59/029

(57) ABSTRACT

The present disclosure describes a pipe assembly. The pipe assembly includes a power source and a pipe body selectively coupled to the power source. The pipe body includes a first piping layer for allowing a content to flow from a proximal end to a distal end of the pipe body, a second piping layer disposed outside of the first piping layer, and at least one heating element disposed between the first and second piping layers for providing heat to the pipe body.

### CROSS REFERENCE TO RELATED APPLICATION(S)

The present disclosure claims the benefit of and priority to Chinese Patent Application No. 202420112542.7, filed with the Chinese Patent Office on Jan. 17, 2024, titled “Built-in Heated Antifreeze Water Pipe”, the entire contents of which are incorporated herein by reference.

### FIELD

Examples of the present disclosure generally relate to a pipe assembly, and in particular to an antifreeze pipe assembly having built-in heating elements.

### BACKGROUND

Outdoor water pipes, such as for supplying gardens and vehicles, are susceptible to damage caused by fluctuating temperatures. During winter, freezing conditions can cause these pipes to freeze and even burst, rendering them unusable. An existing preventative measure is wrapping heating wires on the outside of the pipes. While these cables can provide heat, their effectiveness is limited due to inefficient heat transfer from the outside surface. Additionally, their external placement makes them susceptible to physical wear and tear.

Therefore, there is a need in the art for preventing water pipes from freezing in harsh weather conditions.

### SUMMARY

Systems, methods, and apparatuses are described for preventing water pipes from freezing in harsh weather conditions.

According to a first aspect of the present disclosure, a pipe assembly includes a power source, and a pipe body selectively coupled to the power source. The pipe body includes a first piping layer for allowing a content to flow from a proximal end to a distal end of the pipe body, the first piping layer having a first elastic and electrically insulating material, a second piping layer disposed outside of the first piping layer, the second piping layer having a second elastic and electrically insulating material, and at least one heating element disposed between the first and second piping layers for providing heat to the pipe body.

According to an example of the first aspect, the at least one heating element includes two heating paths, each of the heating paths having two parallel portions arranged along a longitudinal direction of the pipe body and a connecting portion connecting the two parallel portions at the distal end of the pipe body.

According to another example of the first aspect, the at least one heating element comprises two parallel wires arranged helically around the first piping layer and extended along a longitudinal direction of the pipe body and a connecting portion connecting the two parallel wires at the distal end of the pipe body.

According to yet another example of the first aspect, the pipe assembly further includes a thread layer outside of the second piping layer.

According to yet another example of the first aspect, the pipe assembly further includes an outer layer outside of the second piping layer, the outer layer having a thermally insulating material.

According to yet another example of the first aspect, the pipe assembly further includes a temperature controlled switch, where the temperature controlled switch is configured to electrically connect the power source to the at least one heating element to provide heat to the pipe body, when a sensed temperature is lower than a predetermined temperature value.

According to yet another example of the first aspect, the pipe assembly further includes a temperature controlled switch, where the temperature controlled switch is configured to electrically disconnect the at least one heating element from the power source, when a sensed temperature is higher than a predetermined temperature value.

According to a second aspect of the present disclosure, a pipe assembly includes a power source, and a pipe body selectively coupled to the power source. The pipe body includes at least one heating element between a first piping layer and a second piping layer, and a temperature controlled switch configured to electrically connect the at least one heating element to the power source.

According to an example of the second aspect, the at least one heating element comprises two heating paths, each of the heating paths having two parallel portions arranged along a longitudinal direction of the pipe body and a connecting portion connecting the two parallel portions.

According to another example of the second aspect, the at least one heating element comprises two parallel portions arranged helically around the first piping layer and extended along a longitudinal direction of the pipe body and a connecting portion connecting the two parallel portions.

According to yet another example of the second aspect, the pipe assembly further includes a thread layer outside of the second piping layer.

According to yet another example of the second aspect, the pipe assembly further includes an outer layer outside of the second piping layer, the outer layer having a thermally insulating material.

According to yet another example of the second aspect, the temperature controlled switch is configured to electrically connect the power source to the at least one heating element to provide heat to the pipe body, when a sensed temperature is lower than a predetermined temperature value.

According to yet another example of the second aspect, the temperature controlled switch is configured to electrically disconnect the at least one heating element from the power source, when a sensed temperature is higher than a predetermined temperature value.

According to a third aspect of the present disclosure, a pipe body includes a first piping layer for allowing a content to flow from a proximal end to a distal end of the pipe body, the first piping layer having a first elastic and electrically insulating material, a second piping layer disposed outside of the first piping layer, the second piping layer having a second elastic and electrically insulating material, and at least one heating element disposed between the first and second piping layers.

According to an example of the third aspect, the pipe body further includes a thread layer outside of the second piping layer.

According to another example of the third aspect, the pipe body further includes an outer layer outside of the second piping layer, the outer layer having a thermally insulating material.

According to yet another example of the third aspect, the at least one heating element comprises two parallel portions arranged along a longitudinal direction of the pipe body and a connecting portion connecting the two parallel portions at the distal end of the pipe body.

According to yet another example of the third aspect, the at least one heating element comprises two parallel portions arranged helically around the first piping layer and extended along a longitudinal direction of the pipe body and a connecting portion connecting the two parallel portions at the distal end of the pipe body.

According to yet another example of the third aspect, a temperature controlled switch is configured to electrically connect the at least one heating element from a power source when a first sensed temperature is lower than a first predetermined temperature value, and electrically disconnect the at least one heating element from the power source when a second sensed temperature is higher than a second predetermined temperature value.

### BRIEF DESCRIPTION OF THE DRAWINGS

Various aspects of the present disclosure can be better understood with reference to the appended drawings. The components in the drawings are not necessarily drawn to scale, the emphasis instead being placed upon clearly illustrating the principles of the present disclosure. It is to be noted that the appended drawings merely illustrate example implementations and are therefore not to be considered limiting of its scope.

FIG. 1 illustrates a schematic diagram of a cross-sectional view of a pipe body of a pipe assembly, in accordance with an example implementation of the present disclosure.

FIG. 2 illustrates a schematic diagram of one or more heating elements built-in the pipe body shown in FIG. 1, in accordance with an example implementation of the present disclosure.

FIG. 3 illustrates a schematic diagram of a cross-sectional view of a pipe body of a pipe assembly, in accordance with an example implementation of the present disclosure.

FIG. 4 illustrates a schematic diagram of a heating element built-in the pipe body shown in FIG. 3, in accordance with an example implementation of the present disclosure.

FIG. 5 illustrates a schematic circuit diagram of a pipe assembly, in accordance of with example implementation of the present disclosure.

FIG. 6 illustrates a schematic circuit diagram of a pipe assembly, in accordance with an example implementation of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

### Embodiment 1

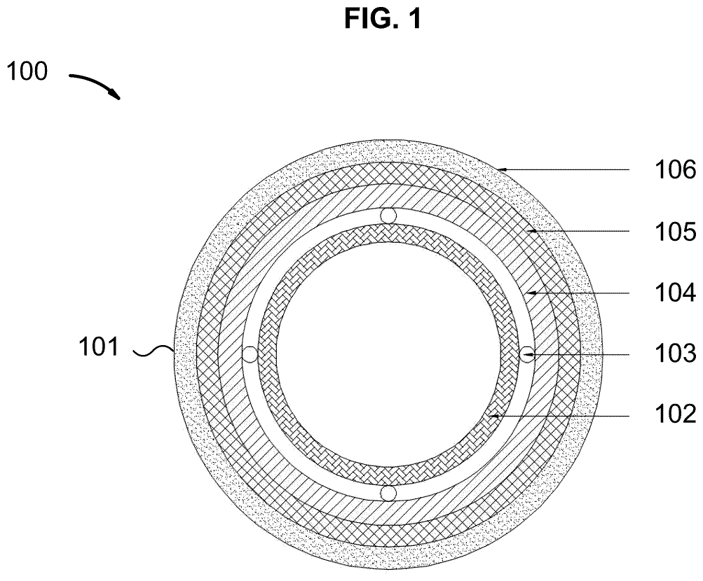

FIGS. 1, 2, 5 and 6 describe a pipe assembly 100 having one or more built-in heating elements, in accordance of an example embodiment of the present disclosure.

As illustrated in FIG. 1, a pipe body 101 includes a first piping layer 102, one or more heating elements 103, a second piping layer 104, a thread layer 105, and an outer layer 106. In the present disclosure, the one or more heating elements 103 may be referred to as a heating layer having heating elements.

In the present embodiment, the first piping layer 102 is the innermost layer of the pipe body 101. The first piping layer 102 can hold a content(s) (e.g., a liquid content(s)) in an interior space thereof, and allow the content(s) to flow through.

The one or more heating elements 103 are provided on an outer exterior wall of the first piping layer 102. When coupled to a power source, the one or more heating elements 103 may generate heat to raise the temperature of the exterior wall of the first piping layer 102.

The second piping layer 104 is provided on the outside of and surrounds the one or more heating elements 103, such that the one or more heating elements 103 are disposed between the first piping layer 102 and the second piping layer 104. In some implementations, the first piping layer 102 and the second piping layer 104 may each include an elastic material, such as a PVC elastic material. In some implementations, the first piping layer 102 and the second piping layer 104 may include other suitable electrically insulating materials.

The thread layer 105 is provided on an outer exterior wall of the second piping layer 104. In some implementations, the thread layer 105 includes polyester yarns laid flat on an outer surface of the second piping layer 104.

The outer layer 106 is provided on the outside of the thread layer 105. In some implementations, the outer layer 106 is the outermost layer that provides an exterior housing for the pipe body 101. In some implementations, the outer layer 106 is made of a thermally insulating material, such as a PVC thermally insulating material.

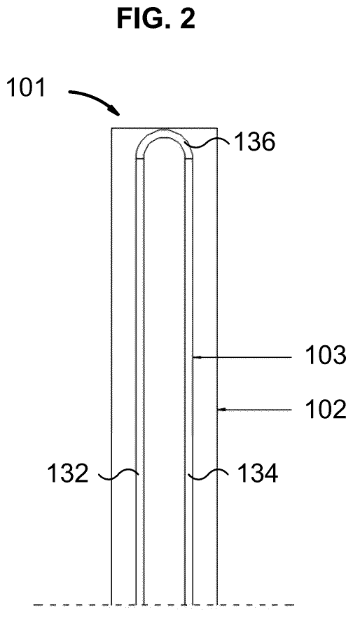

As illustrated in FIGS. 1 and 2, the one or more heating elements 103 may include four heating wires arranged in parallel along a longitudinal direction of the pipe body 101. The four heating wires are grouped into two pairs, the distal ends of each pair of the heating wires are connected together by a connecting wire.

As illustrated in FIG. 2, one of the heating elements 103 is provided on the outer exterior wall of the first piping layer 102. The heating element 103 includes two heating wires 132 and 134 arranged in parallel along the longitudinal direction of the pipe body 101. The heating wires 132 and 134 are connected by a connecting wire 136 at a distal end of the pipe body 101.

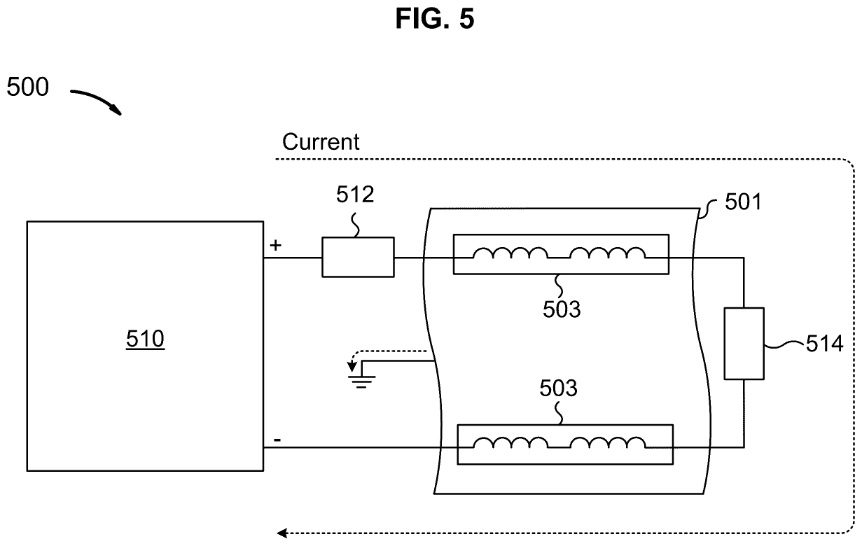

As illustrated in FIG. 5, a pipe assembly 500 includes a pipe body 501, an AC power source 510, a fuse element 512, and a self-restoring temperature protection device 514.

In one implementation, the pipe body 501 may substantially correspond to the pipe body 101 shown in FIGS. 1 and 2. The pipe body 501 includes one or more heating elements 503, which may substantially correspond to the one or more heating elements 103 shown in FIGS. 1 and 2. Thus, the details of the pipe body 501 and the one or more heating elements 503 are omitted for brevity.

As illustrated in FIG. 5, the fuse element 512, the one or more heating elements 503 of the pipe body 501, and the self-restoring temperature protection device 514 are connected in series and electrically coupled to the AC power source 510. In one implementation, the AC power source 510 may provide an AC voltage of 120 volts (VAC).

The self-restoring temperature protection device 514 may be a temperature controlled switch that includes a temperature sensor and a switch controlled based on sensed temperatures by the temperature sensor. For example, when a sensed temperature is lower than a first predetermined threshold (e.g., 7 degrees Celsius), the self-restoring temperature protection device 514 is configured to close a switch therein to allow an AC current to flow through the heating elements 503. As the heating elements 503 are electrically connected to the AC power source 510, heat is generated to maintain or raise the temperature of the pipe body 501 (e.g., including the water therein) and prevent the pipe body 501 from freezing. When the sensed temperature is above a second predetermined threshold (e.g., 15 degrees Celsius), the self-restoring temperature protection device 514 is configured to open the switch to electrically disconnect the heating elements 503 from the AC power source 510, thereby stopping the current from flowing through the heating elements 503.

The use of the temperature sensor in the self-restoring temperature protection device 514 allows the pipe assembly 500 to automatically start heating the pipe body 501 when a sensed temperature falls below a predetermined value to prevent the pipe body 501 from freezing. The temperature sensor also allows the self-restoring temperature protection device 514 to automatically stop heating the pipe body 501 when a sensed temperature is above a predetermined value to save power and prevent damage to the pipe body 501 for example due to overheating.

The self-restoring temperature protection device 514, in addition to being used as a temperature detection switch, can provide current protection. For example, when the current exceeds a predetermined value, the self-restoring temperature protection device 514 is configured to open the switch to stop the current flow.

It should be understood that the self-restoring temperature protection device 514 may be arranged in other suitable locations of the circuit shown in FIG. 5. For example, the self-restoring temperature protection device 514 may be placed between the AC power source 510 and the pipe body 501.

As another protection measure, the fuse element 512 may include a fusing element, such as a metal strip or wire. The fuse element 512 may melt when the load across the meal strip or wire is outside of a normal range or when the current exceeds a predetermined value, to protect the pipe body 501. It should be understood that the fuse element 512 may be arranged in other suitable locations in the circuit shown in FIG. 5.

In one implementation, the pipe assembly 500 may include a ground path/line in the pipe body 501. For example, the ground line may be disposed between the second piping layer 104 and the thread layer 105 shown in FIG. 1. When the pipe body 501 sustains external damages or the AC power line leaks, the heating elements 503 can form a loop with the ground line, thereby triggering leakage protection at the power supply end.

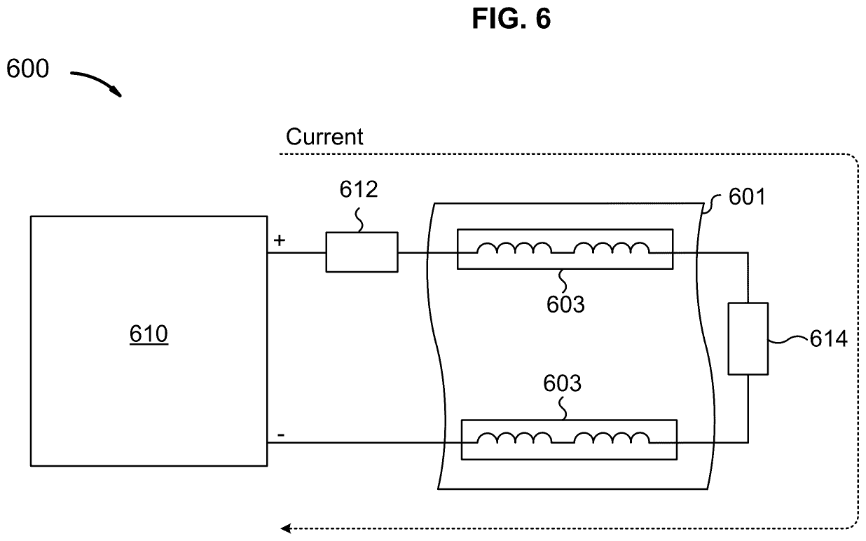

As illustrated in FIG. 6, a pipe assembly 600 includes a pipe body 601, a DC power source 610, a fuse element 612, and a self-restoring temperature protection device 614.

In one implementation, the pipe body 601 may substantially correspond to the pipe body 101 shown in FIGS. 1 and 2. The pipe body 601 includes one or more heating elements 603, which may substantially correspond to the one or more heating elements 103 shown in FIGS. 1 and 2. Thus, the details of the pipe body 601 and the one or more heating elements 603 are omitted for brevity.

As illustrated in FIG. 6, the fuse element 612, the one or more heating elements 603 of the pipe body 601, and the self-restoring temperature protection device 614 are connected in series and electrically coupled to the DC power source 610.

In one implementation, the DC power source 610 may provide a DC voltage of 12 or 24 volts (VDC). In one implementation, the DC power source 610 may receive an AC input and provide a DC output. For example, the DC power source 610 may include a power adapter that can convert an AC input to a DC output (e.g., from an 120 VAC input to a 12 or 24 VDC output).

The self-restoring temperature protection device 614 may be a temperature controlled switch that includes a temperature sensor and a switch controlled based on sensed temperatures by the temperature sensor. For example, when a sensed temperature is lower than a first predetermined threshold (e.g., 7 degrees Celsius), the self-restoring temperature protection device 614 is configured to close a switch therein to allow a DC current to flow through the heating elements 603. As the heating elements 603 are electrically connected to the DC power source 610, heat is generated to maintain or raise the temperature of the pipe body 601 (e.g., including the water therein) and prevent the pipe body 601 from freezing. When the sensed temperature is above a second predetermined threshold (e.g., 15 degrees Celsius), the self-restoring temperature protection device 614 is configured to open the switch to electrically disconnect the heating elements 603 from the DC power source 610, thereby stopping the current from flowing through the heating elements 603.

The use of the temperature sensor in the self-restoring temperature protection device 614 allows the pipe assembly 600 to automatically start heating the pipe body 601 when a sensed temperature falls below a predetermined value to prevent the pipe body 601 from freezing. The temperature sensor also allows the self-restoring temperature protection device 614 to automatically stop heating the pipe body 601 when a sensed temperature is above a predetermined value to save power and prevent damage to the pipe body 601 for example due to overheating.

Because the heating elements 603 are electrically coupled to a low DC voltage (e.g., 12 or 24 VDC), the risk of electric shock to the human body can be substantially eliminated.

The self-restoring temperature protection device 614, in addition to being used as a temperature detection switch, can also provide current protection. For example, the power adapter in the DC power source 610 is selected to match the power of the electric heating wire(s). When the pipe body 601 experiences an abnormal amount of power due to external damage, the power adapter can automatically cut off the power output.

It should be understood that the self-restoring temperature protection device 614 may be arranged in other suitable locations of the circuit shown in FIG. 6. For example, the self-restoring temperature protection device 614 may be placed between the DC power source 610 and the pipe body 601.

As another protection measure, the fuse element 612 may include a fusing element, such as a metal strip or wire. The fuse element 612 may melt when the load across the meal strip or wire is outside of a normal range or when the current exceeds a predetermined value, to protect the pipe body 601. It should be understood that the fuse element 612 may be arranged in other suitable locations in the circuit shown in FIG. 6.

In the present disclosure, four heating wires are installed on the pipe body 601 along the direction in which it extends, and the front ends of each two heating wires (e.g., the heating wires 132 and 134 in FIG. 2) are connected by a connecting wire (e.g., the connecting wire 136 in FIG. 2) to increase the temperature of the pipe body 601.

As the heating elements 603 are in direct contact with the innermost piping layer (e.g., the first piping layer 102 in FIGS. 1 and 2), the heat transfer from the heating elements 603 is fast and efficient. As there are multiple protective layers on the outside of the heating wires, the heating elements 603 are protected and thermally insulated from the outside cold temperature to avoid rapid loss of heat.

### Embodiment 2

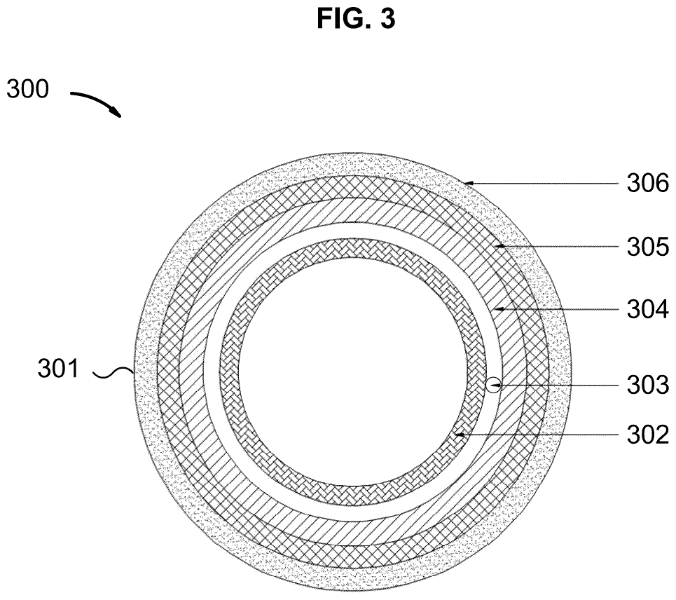

FIGS. 3, 4, 5 and 6 describe a pipe assembly 300 having one or more built-in heating elements, in accordance of an example embodiment of the present disclosure.

As illustrated in FIG. 3, a pipe body 301 includes a first piping layer 302, one or more heating elements 303, a second piping layer 304, a thread layer 305, and an outer layer 306. In the present disclosure, the one or more heating elements 303 may be referred to as a heating layer having heating elements.

In the present embodiment, the first piping layer 302 is the innermost layer of the pipe body 301. The first piping layer 302 can hold a content(s) (e.g., a liquid content(s)) in an interior space thereof, and allow the content(s) to flow through.

The one or more heating elements 303 are provided on an outer exterior wall of the first piping layer 302. When coupled to a power source, the one or more heating elements 303 may generate heat to raise the temperature of the exterior wall of the first piping layer 302.

The second piping layer 304 is provided on the outside of and surrounds the one or more heating elements 303, such that the one or more heating elements 303 are disposed between the first piping layer 302 and the second piping layer 304. In some implementations, the first piping layer 302 and the second piping layer 304 may each include an elastic material, such as a PVC elastic material. In some implementations, the first piping layer 302 and the second piping layer 304 may include other suitable electrically insulating materials.

The thread layer 305 is provided on an outer exterior wall of the second piping layer 304. In some implementations, the thread layer 305 includes polyester yarns laid flat on an outer surface of the second piping layer 304.

The outer layer 306 is provided on the outside of the thread layer 305. In some implementations, the outer layer 306 is the outermost layer that provides an exterior housing for the pipe body 301. In some implementations, the outer layer 306 is made of a thermally insulating material, such as a PVC thermally insulating material.

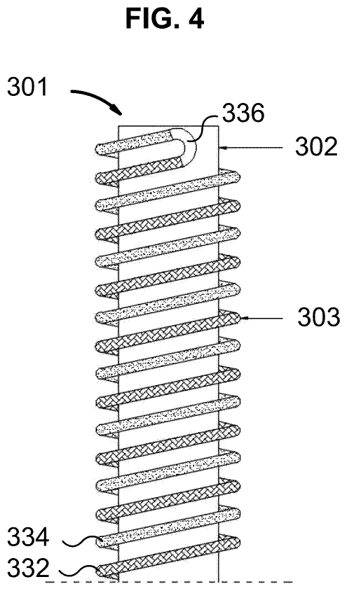

As illustrated in FIG. 4, the one or more heating elements 303 may include two heating wires 332 and 334 arranged helically around the first piping layer 302 and extended along a longitudinal direction of the pipe body 301. The distal ends of the two heating wires 332 and 334 are connected together by a connecting wire 336.

As illustrated in FIG. 5, a pipe assembly 500 includes a pipe body 501, an AC power source 510, a fuse element 512, and a self-restoring temperature protection device 514.

In one implementation, the pipe body 501 may substantially correspond to the pipe body 301 shown in FIGS. 3 and 4. The pipe body 501 includes one or more heating elements 503, which may substantially correspond to the one or more heating elements 303 shown in FIGS. 3 and 4. Thus, the details of the pipe body 501 and the one or more heating elements 503 are omitted for brevity.

As illustrated in FIG. 5, the fuse element 512, the one or more heating elements 503 of the pipe body 501, and the self-restoring temperature protection device 514 are connected in series and electrically coupled to the AC power source 510. In one implementation, the AC power source 510 may provide an AC voltage of 120 volts (VAC).

The self-restoring temperature protection device 514 may be a temperature controlled switch that includes a temperature sensor and a switch controlled based on sensed temperatures by the temperature sensor. For example, when a sensed temperature is lower than a first predetermined threshold (e.g., 7 degrees Celsius), the self-restoring temperature protection device 514 is configured to close a switch therein to allow an AC current to flow through the heating elements 503. As the heating elements 503 are electrically connected to the AC power source 510, heat is generated to maintain or raise the temperature of the pipe body 501 (e.g., including the water therein) and prevent the pipe body 501 from freezing. When the sensed temperature is above a second predetermined threshold (e.g., 15 degrees Celsius), the self-restoring temperature protection device 514 is configured to open the switch to electrically disconnect the heating elements 503 from the AC power source 510, thereby stopping the current from flowing through the heating elements 503.

The use of the temperature sensor in the self-restoring temperature protection device 514 allows the pipe assembly 500 to automatically start heating the pipe body 501 when a sensed temperature falls below a predetermined value to prevent the pipe body 501 from freezing. The temperature sensor also allows the self-restoring temperature protection device 514 to automatically stop heating the pipe body 501 when a sensed temperature is above a predetermined value to save power and prevent damage to the pipe body 501 for example due to overheating.

The self-restoring temperature protection device 514, in addition to being used as a temperature detection switch, can provide current protection. For example, when the current exceeds a predetermined value, the self-restoring temperature protection device 514 is configured to open the switch to stop the current flow.

It should be understood that the self-restoring temperature protection device 514 may be arranged in other suitable locations of the circuit shown in FIG. 5. For example, the self-restoring temperature protection device 514 may be placed between the AC power source 510 and the pipe body 501.

As another protection measure, the fuse element 512 may include a fusing element, such as a metal strip or wire. The fuse element 512 may melt when the load across the meal strip or wire is outside of a normal range or when the current exceeds a predetermined value, to protect the pipe body 501. It should be understood that the fuse element 512 may be arranged in other suitable locations in the circuit shown in FIG. 5.

In one implementation, the pipe assembly 500 may include a ground path/line in the pipe body 501. For example, the ground line may be disposed between the second piping layer 304 and the thread layer 305 shown in FIG. 3. When the pipe body 501 sustains external damages or the AC power line leaks, the heating elements 503 can form a loop with the ground line, thereby triggering leakage protection at the power supply end.

As illustrated in FIG. 6, a pipe assembly 600 includes a pipe body 601, a DC power source 610, a fuse element 612, and a self-restoring temperature protection device 614.

In one implementation, the pipe body 601 may substantially correspond to the pipe body 301 shown in FIGS. 3 and 4. The pipe body 601 includes one or more heating elements 603, which may substantially correspond to the one or more heating elements 303 shown in FIGS. 3 and 4. Thus, the details of the pipe body 601 and the one or more heating elements 603 are omitted for brevity.

As illustrated in FIG. 6, the fuse element 612, the one or more heating elements 603 of the pipe body 601, and the self-restoring temperature protection device 614 are connected in series and electrically coupled to the DC power source 610.

In one implementation, the DC power source 610 may provide a DC voltage of 12 or 24 volts (VDC). In one implementation, the DC power source 610 may receive an AC input and provide a DC output. For example, the DC power source 610 may include a power adapter that can convert an AC input to a DC output (e.g., from an 120 VAC input to a 12 or 24 VDC output).

The self-restoring temperature protection device 614 may be a temperature controlled switch that includes a temperature sensor and a switch controlled based on sensed temperatures by the temperature sensor. For example, when a sensed temperature is lower than a first predetermined threshold (e.g., 7 degrees Celsius), the self-restoring temperature protection device 614 is configured to close a switch therein to allow a DC current to flow through the heating elements 603. As the heating elements 603 are electrically connected to the DC power source 610, heat is generated to maintain or raise the temperature of the pipe body 601 (e.g., including the water therein) and prevent the pipe body 601 from freezing. When the sensed temperature is above a second predetermined threshold (e.g., 15 degrees Celsius), the self-restoring temperature protection device 614 is configured to open the switch to electrically disconnect the heating elements 603 from the DC power source 610, thereby stopping the current from flowing through the heating elements 603.

The use of the temperature sensor in the self-restoring temperature protection device 614 allows the pipe assembly 600 to automatically start heating the pipe body 601 when a sensed temperature falls below a predetermined value to prevent the pipe body 601 from freezing. The temperature sensor also allows the self-restoring temperature protection device 614 to automatically stop heating the pipe body 601 when a sensed temperature is above a predetermined value to save power and prevent damage to the pipe body 601 for example due to overheating.

Because the heating elements 603 are electrically coupled to a low DC voltage (e.g., 12 or 24 VDC), the risk of electric shock to the human body can be substantially eliminated.

The self-restoring temperature protection device 614, in addition to being used as a temperature detection switch, can also provide current protection. For example, the power adapter in the DC power source 610 is selected to match the power of the electric heating wire(s). When the pipe body 601 experiences an abnormal amount of power due to external damage, the power adapter can automatically cut off the power output.

It should be understood that the self-restoring temperature protection device 614 may be arranged in other suitable locations of the circuit shown in FIG. 6. For example, the self-restoring temperature protection device 614 may be placed between the DC power source 610 and the pipe body 601.

As another protection measure, the fuse element 612 may include a fusing element, such as a metal strip or wire. The fuse element 612 may melt when the load across the meal strip or wire is outside of a normal range or when the current exceeds a predetermined value, to protect the pipe body 601. It should be understood that the fuse element 612 may be arranged in other suitable locations in the circuit shown in FIG. 6.

In the present disclosure, two heating wires are arranged helically around the pipe body 601, and the front ends of each heating wire (e.g., the heating wires 332 and 334 in FIG. 4) are connected by a connecting wire (e.g., the connecting wire 336 in FIG. 4) to increase the temperature of the pipe body 601.

As the heating elements 603 are in direct contact with the innermost piping layer (e.g., the first piping layer 302 in FIGS. 3 and 4), the heat transfer from the heating elements 603 is fast and efficient. As there are multiple protective layers on the outside of the heating wires, the heating elements 603 are protected and thermally insulated from the outside cold temperature to avoid rapid loss of heat.

The embodiments of the present disclosure provide one or more heating elements disposed on an exterior wall of the innermost piping layer of a pipe assembly to provide heat to the pipe body in a predetermined temperature range. The heating elements are disposed between two electrically insulating piping layers that are made of elastic materials. The pipe assembly also includes a temperature controlled switch that automatically connects the heating elements to a power source when a sensed temperature falls below a predetermined value to prevent contents in the pipe from freezing. Conversely, the switch automatically disconnects the heating elements from the power source when a sensed temperature raises above a predetermined value to avoid unnecessary power consumption. The pipe assembly further includes multiple protective layers surrounding the heating elements for efficient heat transfer and durability.

It should be noted that the above are only preferred embodiments of the present disclosure and are not intended to limit the present disclosure. Although the present disclosure has been described in detail with reference to the foregoing embodiments, for those skilled in the art, it is still possible to modify the technical solutions recorded in the foregoing embodiments, or to perform equivalent substitutions on some of the technical features. Any modifications, equivalent substitutions, improvements, etc. made within the spirit and principles of the present disclosure, All should be included in the protection scope of this present disclosure.

What is claimed is:

1. A pipe assembly, comprising:
a power source; and
a pipe body selectively coupled to the power source;
wherein the pipe body comprises:
a first piping layer for allowing a content to flow from a proximal end to a distal end of the pipe body, the first piping layer having a first elastic and electrically insulating material;
a second piping layer disposed outside of the first piping layer, the second piping layer having a second elastic and electrically insulating material; and
at least one heating element disposed between the first and second piping layers for providing heat to the pipe body.

2. The pipe assembly of claim 1, wherein the at least one heating element comprises two heating paths, each of the heating paths having two parallel portions arranged along a longitudinal direction of the pipe body and a connecting portion connecting the two parallel portions at the distal end of the pipe body.

3. The pipe assembly of claim 1, wherein the at least one heating element comprises two parallel wires arranged helically around the first piping layer and extended along a longitudinal direction of the pipe body and a connecting portion connecting the two parallel wires at the distal end of the pipe body.

4. The pipe assembly of claim 1, further comprising a thread layer outside of the second piping layer.

5. The pipe assembly of claim 1, further comprising an outer layer having a thermally insulating material.

6. The pipe assembly of claim 1, further comprising a temperature controlled switch, wherein the temperature controlled switch is configured to electrically connect the power source to the at least one heating element to provide heat to the pipe body, when a sensed temperature is lower than a predetermined temperature value.

7. The pipe assembly of claim 1, further comprising a temperature controlled switch, wherein the temperature controlled switch is configured to electrically disconnect the at least one heating element from the power source, when a sensed temperature is higher than a predetermined temperature value.

8. A pipe assembly, comprising:
a power source; and
a pipe body selectively coupled to the power source;
wherein the pipe body comprises:
at least one heating element disposed between a first piping layer and a second piping layer; and
a temperature controlled switch configured to electrically connect the at least one heating element to the power source.

9. The pipe assembly of claim 8, wherein the at least one heating element comprises two heating paths, each of the heating paths having two parallel portions arranged along a longitudinal direction of the pipe body and a connecting portion connecting the two parallel portions.

10. The pipe assembly of claim 8, wherein the at least one heating element comprises two parallel portions arranged helically around the first piping layer and extended along a longitudinal direction of the pipe body and a connecting portion connecting the two parallel portions.

11. The pipe assembly of claim 8, further comprising a thread layer outside of the second piping layer.

12. The pipe assembly of claim 8, further comprising an outer layer outside of the second piping layer, the outer layer having a thermally insulating material.

13. The pipe assembly of claim 8, wherein the temperature controlled switch is configured to electrically connect the power source to the at least one heating element to provide heat to the pipe body, when a sensed temperature is lower than a predetermined temperature value.

14. The pipe assembly of claim 8, wherein the temperature controlled switch is configured to electrically disconnect the at least one heating element from the power source, when a sensed temperature is higher than a predetermined temperature value.

15. A pipe body, comprising:
a first piping layer for allowing a content to flow from a proximal end to a distal end of the pipe body, the first piping layer having a first elastic and electrically insulating material;
a second piping layer outside of the first piping layer, the second piping layer having a second elastic and electrically insulating material; and
at least one heating element disposed between the first and second piping layers.

16. The pipe body of claim 15, further comprising a thread layer outside of the second piping layer.

17. The pipe body of claim 15, further comprising an outer layer outside of the second piping layer, the outer layer having a thermally insulating material.

18. The pipe body of claim 15, wherein the at least one heating element comprises two parallel portions arranged along a longitudinal direction of the pipe body and a connecting portion connecting the two parallel portions at a distal end of the pipe body.

19. The pipe body of claim 15, wherein the at least one heating element comprises two parallel portions arranged helically around the first piping layer and extended along a longitudinal direction of the pipe body and a connecting portion connecting the two parallel portions at a distal end of the pipe body.

20. The pipe body of claim 15, further comprising a temperature controlled switch, wherein the temperature controlled switch is configured to:
electrically connect the at least one heating element from a power source when a first sensed temperature is lower than a first predetermined temperature value; and
electrically disconnect the at least one heating element from the power source when a second sensed temperature is higher than a second predetermined temperature value.
